(19) United States
(12) Patent Application Publication
(10) Pub. No.: US 2021/0405782 A1
(43) Pub. Date: Dec. 30, 2021

(54) TOUCH MODULE AND TOUCH DISPLAY MODULE

(71) Applicant: TPK Advanced Solutions Inc., Xiamen (CN)

(72) Inventors: Qi Bin Liu, Shanghang County (CN); Kuolung Fang, Zhudong Township (TW); Yamei Chen, Xiamen City (CN); Yating Hsu, Lunbei Township (TW)

(21) Appl. No.: 17/078,514

(22) Filed: Oct. 23, 2020

(30) Foreign Application Priority Data
Jun. 28, 2020 (CN) 202010600381.2

(51) Int. Cl. G06F 3/041

(52) U.S. Cl. CPC G06F 3/041; G06F 2203/04102; G06F 2203/04103

(57) ABSTRACT

A touch module includes a substrate, a transparent conductive layer disposed on the substrate, and at least one of a water vapor barrier layer or an optically clear adhesive layer transversely extending on the transparent conductive layer. The water vapor barrier layer covers the transparent conductive layer and includes. The optically clear adhesive layer has a water absorption at saturation of 0.08% to 0.40% and a water vapor permeability of 37 g/(m²*day) to 1650 g/(m²*day). A touch display module including the touch module and a display panel is further provided.

### RELATED APPLICATIONS

This application claims priority to China Application Serial Number 202010600381.2, filed Jun. 28, 2020, which is herein incorporated by reference.

### BACKGROUND

### Field of Disclosure

The present disclosure relates to the technical field of touch control, and in particular, to a touch module with high water resistance and a touch display module.

### Description of Related Art

In recent years, as touch technology has developed, transparent conductors are often applied in many display or touch-related devices since transparent conductors can allow light to pass through while providing proper conductivity. In general, the transparent conductors may be various metal oxides, such as indium tin oxide (ITO), indium zinc oxide (IZO), cadmium tin oxide (CTO) or aluminum-doped zinc oxide (AZO). However, films made of these metal oxides cannot meet the flexibility requirements of display devices. Therefore, a variety of flexible transparent conductors, such as a transparent conductor made of a material such as a metal nanowire, have been developed nowadays.

However, there are still many problems to be solved for display or touch devices made of the metal nanowires. For example, when the metal nanowires are used to make a touch electrode, a polymer film may be used in combination with the metal nanowires. However, the polymer film is often made of organic materials, and the polymer film often extends to a peripheral region of a device, resulting in exposure. Therefore, water vapor/moisture in the environment is prone to intrude through the polymer film, resulting in insufficient reliability of the metal nanowires.

### SUMMARY

In order to solve the problem of electromigration of metal nanowires caused by excessively fast water vapor intrusion, the present disclosure provides a touch module with a water vapor barrier layer and/or an optically clear adhesive layer made of a suitable material and a touch display module. The water vapor barrier layer and the optically clear adhesive layer made of a suitable material can reduce water vapor intrusion to avoid the electromigration of the metal nanowires or slow down the electromigration time of the metal nanowires, thereby meeting the specification requirements of improving product reliability tests.

The technical solution adopted by the present disclosure is a touch module which includes a substrate, a transparent conductive layer, and a water vapor barrier layer. The transparent conductive layer is disposed on the substrate. The water vapor barrier layer transversely extends on the transparent conductive layer, covers the transparent conductive layer, and includes an inorganic material.

In some embodiments, the inorganic material includes a silicon nitrogen compound (SiNₓ), a silicon oxygen compound, or combinations thereof.

In some embodiments, the water vapor barrier layer has a thickness of 30 nm to110 nm.

In some embodiments, the water vapor barrier layer extends to an inner surface of the substrate along a sidewall of the transparent conductive layer.

In some embodiments, the transparent conductive layer includes a matrix and a plurality of metal nanostructures distributed in the matrix.

In some embodiments, the touch module further includes at least one coating layer disposed between the water vapor barrier layer and the transparent conductive layer.

In some embodiments, the water vapor barrier layer extends along a sidewall of the coating layer to cover the coating layer.

In some embodiments, the touch module further includes a light shielding layer disposed between the transparent conductive layer and the substrate.

In some embodiments, the water vapor barrier layer extends along a sidewall of the light shielding layer to cover the light shielding layer.

In some embodiments, the touch module may further include an optically clear adhesive layer disposed between the water vapor barrier layer and the transparent conductive layer, wherein the optically clear adhesive layer has a water absorption at saturation of 0.08% to 0.40%.

Another technical solution adopted by the present disclosure is a touch module which includes a substrate, a transparent conductive layer, and an optically clear adhesive layer. The transparent conductive layer is disposed on the substrate. The optically clear adhesive layer transversely extends on the transparent conductive layer, wherein the optically clear adhesive layer has a water absorption at saturation of 0.08% to 0.40% and a water vapor permeability of 37 g/(m²*day) to 1650 g/(m²*day).

In some embodiments, the optically clear adhesive layer has a dielectric constant of 2.24 to 4.30.

In some embodiments, the optically clear adhesive layer has a thickness of 150 μm to 200 μm.

In some embodiments, the optically clear adhesive layer extends to an inner surface of the substrate along a sidewall of the transparent conductive layer.

In some embodiments, the touch module further includes at least one coating layer disposed between the optically clear adhesive layer and the transparent conductive layer.

In some embodiments, the optically clear adhesive layer extends along a sidewall of the coating layer to cover the coating layer.

In some embodiments, the touch module further includes a light shielding layer disposed between the transparent conductive layer and the substrate.

In some embodiments, the optically clear adhesive layer extends along a sidewall of the light shielding layer to cover the light shielding layer.

In some embodiments, the optically clear adhesive layer extends to an inner surface of the light shielding layer along a sidewall of the transparent conductive layer.

In some embodiments, the touch module may further include a water vapor barrier layer disposed between the optically clear adhesive layer and the transparent conductive layer, wherein the water vapor barrier layer includes an inorganic material.

Another technical solution adopted by the present disclosure is a touch display module which includes a substrate, a transparent conductive layer, a water vapor barrier layer, and a display panel. The transparent conductive layer is disposed on the substrate. The water vapor barrier layer transversely extends on the transparent conductive layer, covers the transparent conductive layer, and includes an inorganic material. The display panel is disposed on the water vapor barrier layer.

The present disclosure provides a touch module with a water vapor barrier layer and/or an optically clear adhesive layer made of a suitable material. The water vapor barrier layer and/or the optically clear adhesive layer made of the suitable material can reduce water vapor intrusion. The optically clear adhesive layer made of the suitable material can also slow down the water vapor transmission and the migration rate of metal ions generated by metal nanowires, in order to avoid electromigration of the metal nanowires or slow down the electromigration time of the metal nanowires, thereby meeting the specification requirements of improving product reliability tests.

### BRIEF DESCRIPTION OF THE DRAWINGS

The disclosure can be more fully understood by reading the following detailed description of the embodiments, with reference made to the accompanying drawings as follows:

FIG. 1 is a schematic side view of a touch module according to some embodiments of the present disclosure;

FIG. 2 is a schematic side view of a touch module according to some other embodiments of the present disclosure;

FIG. 3 is a schematic side view of a touch module according to some other embodiments of the present disclosure;

FIG. 4 is a schematic side view of a touch module according to some other embodiments of the present disclosure;

FIG. 5 is a schematic side view of a touch module according to some other embodiments of the present disclosure;

FIG. 6 is a schematic side view of a touch module according to some other embodiments of the present disclosure;

FIG. 7 is a schematic side view of a touch module according to some other embodiments of the present disclosure;

FIG. 8 is a graph of the dielectric constant vs. reliability test results drawn according to each embodiment in Table 1;

FIG. 9 is a graph of the water absorption at saturation vs. reliability test results drawn according to each embodiment in Table 1; and

FIG. 10 is a schematic side view of a touch module according to some other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In addition, relative terms such as “lower” or “bottom” and “upper” or “top” can be used herein to describe the relationship between one element and another element, as shown in the figure. It should be understood that relative terms are intended to include different orientations of the device other than those shown in the figures. For example, if the device in one figure is turned over, elements described as being on the “lower” side of other elements will be oriented on the “upper” side of the other elements. Therefore, the exemplary term “lower” may include an orientation of “lower” and “upper”, depending on the specific orientation of the drawing. Similarly, if the device in one figure is turned over, elements described as “below” other elements will be oriented “above” the other elements. Therefore, the exemplary term “below” can include an orientation of “above” and “below”.

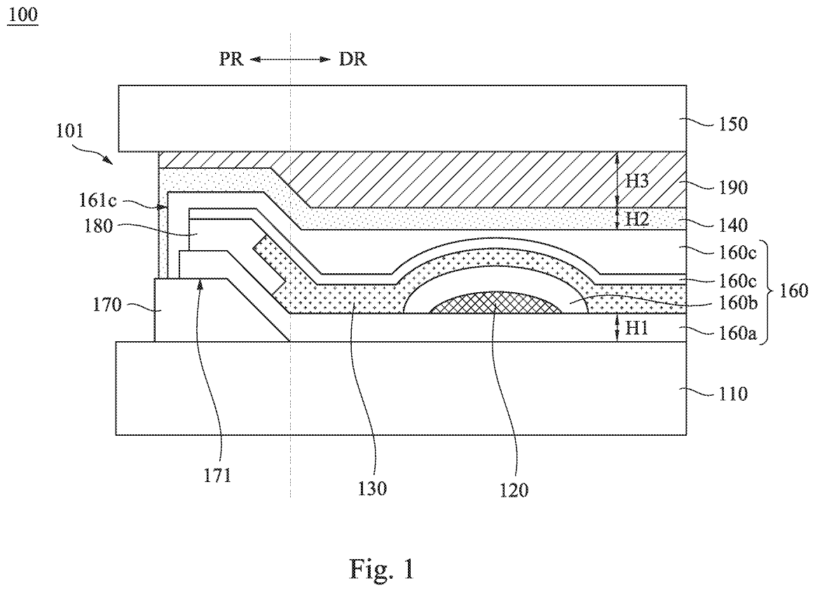

Reference is made to FIG. 1, which is a schematic side view of a touch module 100 according to some embodiments of the present disclosure. The touch module 100 may include a substrate 110, a first transparent conductive layer 120, a second transparent conductive layer 130, and a water vapor barrier layer 140. The first transparent conductive layer 120, the second transparent conductive layer 130, and the water vapor barrier layer 140 are sequentially stacked above the substrate 110. The touch module 100 further includes a plurality of coating layers 160 which may be disposed, for example, between the substrate 110 and the first transparent conductive layer 120 and between the first transparent conductive layer 120 and the second transparent conductive layer 130. In some embodiments, the touch module 100 further includes a display panel 150 stacked above the water vapor barrier layer 140, such that the touch module 100 can further serve as a touch display module. In some embodiments, the coating layers 160 may also be disposed, for example, between the second transparent conductive layer 130 and the display panel 150. In addition, when the touch module 100 is configured to serve as a touch display module, the touch module 100 has a display region DR and a peripheral region PR, and the peripheral region PR can be provided with a light shielding layer 170 for shielding light, which can be made of, for example, a dark photoresist or other opaque metal materials. At least one side surface 101 of the peripheral region PR of the touch module 100 is a water vapor intrusion surface. In the present disclosure, the water vapor barrier layer 140 is disposed to extend a path and time required for water vapor intrusion, in order to protect various electrodes (e.g., the first transparent conductive layer 120 and the second transparent conductive layer 130) in the touch module 100, thereby meeting the specification requirements of improving product reliability tests, which will be explained in more detail in the following descriptions.

In some embodiments, the first transparent conductive layer 120 can be disposed in a first axial direction (e.g., x axis) to transmit a touch sensing signal of the touch module 100 in the first axial direction to the peripheral region PR for subsequent processing. In other words, the first transparent conductive layer 120 can serve as a horizontal touch sensing electrode. In some embodiments, the first transparent conductive layer 120 may be, for example, an indium tin oxide conductive layer. In other embodiments, the first transparent conductive layer 120 may also be, for example, an indium zinc oxide, cadmium tin oxide, or aluminum-doped zinc oxide conductive layer. Since the foregoing materials have an excellent light transmittance, when the touch module 100 is configured to serve as a touch display module, the foregoing materials will not affect the optical properties (e.g., the optical transmittance and clarity) of the touch display module 100.

In some embodiments, the second transparent conductive layer 130 can be disposed in a second axial direction (e.g., y axis) to transmit a touch sensing signal of the touch module 100 in the second axial direction to the peripheral region PR for subsequent processing. In other words, the second transparent conductive layer 130 can serve as a vertical touch sensing electrode. In some embodiments, the second transparent conductive layer 130 may include a matrix and a plurality of metal nanowires (also called metal nanostructures) distributed in the matrix. The matrix may include polymers or a mixture thereof to impart specific chemical, mechanical, and optical properties to the second transparent conductive layer 130. For example, the matrix can provide a good adhesion between the second transparent conductive layer 130 and other layers. As another example, the matrix can also provide a good mechanical strength for the second transparent conductive layer 130. In some embodiments, the matrix may include a specific polymer, such that the second transparent conductive layer 130 has an additional scratch/wear-resistant surface protection, thereby improving the surface strength of the second transparent conductive layer 130. The foregoing specific polymer may be, for example, polyacrylate, polyurethane, epoxy resin, polysiloxane, polysilane, poly(silicon-acrylic acid), or combinations thereof. In some embodiments, the matrix may further include a cross-linking agent, a surfactant, a stabilizer (including, but not limited to, an antioxidant or an ultraviolet stabilizer, for example), a polymerization inhibitor, or combinations thereof, in order to improve the ultraviolet resistance of the second transparent conductive layer 130 and prolong its service life.

In some embodiments, the metal nanowires may include, but are not limited to, silver nanowires, gold nanowire, copper nanowires, nickel nanowires, or combinations thereof. More specifically, the term “metal nanowire” is used herein is a collective noun, which refers to a collection of metal wires of a plurality of metal elements, metal alloys, or metal compounds (including metal oxides). In addition, the number of metal nanowires included in the second transparent conductive layer 130 is not intended to limit the present disclosure. Since the metal nanowires of the present disclosure have an excellent light transmittance, when the touch module 100 is configured to serve as a touch display module, the metal nanowires can provide a good conductivity for the second transparent conductive layer 130 without affecting the optical properties of the touch display module 100.

In some embodiments, a cross-sectional size of a single metal nanowire (the diameter of the cross-section) may be less than 500 nm, preferably less than 100 nm, and more preferably less than 50 nm, such that the second transparent conductive layer 130 has a lower haze. In detail, when the cross-sectional size of the single metal nanowire is greater than 500 nm, the single metal nanowire is excessively thick, resulting in excessively high haze of the second transparent conductive layer 130, thus affecting the visual clarity of the display region DR. In some embodiments, an aspect ratio (length:diameter) of the single metal nanowire may be 10 to 100,000, such that the second transparent conductive layer 130 may have a lower electrical resistivity, a higher light transmittance, and a lower haze. In detail, when the aspect ratio of a single metal nanowire is less than 10, a conductive network may not be well formed, resulting in an excessively high resistivity of the second transparent conductive layer 130. Therefore, the metal nanowires must be distributed in the matrix with a greater arrangement density (i.e., the number of metal nanowires included in the second transparent conductive layer 130 per unit volume) in order to improve the conductivity of the second transparent conductive layer 130, such that the second transparent conductive layer 130 has an excessively low light transmittance and an excessively high haze. It should be understood that other terms, such as silk, fiber, or tube can also have the foregoing cross-sectional sizes and aspect ratios and are also covered by the present disclosure.

As mentioned above, the coating layers 160 may be disposed between the substrate 110 and the first transparent conductive layer 120, between the first transparent conductive layer 120 and the second transparent conductive layer 130, and between the second transparent conductive layer 130 and the display panel 150, in order to achieve the effects of protection, insulation, or adhesion. In some embodiments, the coating layer 160 disposed between the substrate 110 and the first transparent conductive layer 120 may also be referred to as a bottom coating layer 160a, the coating layer 160 disposed between the first transparent conductive layer 120 and the second transparent conductive layer 130 may also be referred to as an intermediate coating layer 160b, and the coating layer 160 disposed between the second transparent conductive layer 130 and the display panel 150 may also be referred to as a top coating layer 160c. In some embodiments, the bottom coating layer 160a and the top coating layer 160c can further extend to an inner surface 171 (i.e., a surface of the light shielding layer 170 facing away from the substrate 110) of the light shielding layer 170 located in the peripheral region PR. In some embodiments, the top coating layer 160c can transversely extend and cover the entire second transparent conductive layer 130. In some embodiments, the top coating layer 160c may be two or more layers (e.g., two layers), but the present disclosure is not limited in this regard. In some embodiments, the topmost coating layer 160c can further extend to the inner surface 171 of the light shielding layer 170 along the sidewall of each layer (e.g., sidewalls of both any other top coating layer 160c and the bottom coating layer 160a) to protect the touch module 100 from a side surface of the touch module 100. In some embodiments, the touch module 100 may further include a metal trace 180 located in the peripheral region PR and between the top coating layer 160c and the bottom coating layer 160a. The metal trace 180 can electrically connect the second transparent conductive layer 130 to a flexible circuit board (not shown) to further transmit a touch sensing signal generated by the second transparent conductive layer 130 to an external integrated circuit for subsequent processing, and the topmost coating layer 160c can further extend to the inner surface 171 of the light shielding layer 170 along a sidewall of the metal trace 180. In some embodiments, a thickness H1 of the bottom coating layer 160a may be between 20 nm and 10 μm, between 50 nm and 200 nm, or between 30 nm and 100 nm, in order to achieve good protection, insulation, or adhesion effects and avoid an excessively large thickness of the entire touch module 100. In detail, when the thickness H1 of the bottom coating layer 160a is less than the foregoing lower limit, the bottom coating layer 160a may fail to provide good protection, insulation, or adhesion functions; when the thickness H1 of the bottom coating layer 160a is greater than the foregoing upper limit, the entire touch module 100 may have an excessively large thickness, which is unfavorable for the manufacturing process and seriously affects the appearance.

In some embodiments, the top coating layer 160c can form a composite structure with the second transparent conductive layer 130 to have certain specific chemical, mechanical, and optical properties. For example, the top coating layer 160c can provide a good adhesion between the composite structure and other layers. As another example, the top coating layer 160c can provide a good mechanical strength for the composite structure. In some embodiments, the top coating layer 160c may include a specific polymer, such that the composite structure has an additional scratch-resistant and wear-resistant surface protection, thereby improving the surface strength of the composite structure. The foregoing specific polymer may be, for example, polyacrylate, polyurethane, epoxy resin, polysilane, polysiloxane, poly(silicon-acrylic acid), or combinations thereof. It should be noted that the top coating layer 160c and the second transparent conductive layer 130 are shown as different layers in accompanying drawings herein. However, in some embodiments, the material used to make the top coating layer 160c can penetrate, before being cured or in a pre-cured state, between metal nanowires of the second transparent conductive layer 130 to form a filler, such that the metal nanowires can also be embedded in the top coating layer 160c after the top coating layer 160c is cured.

In some embodiments, the material of the coating layer 160 may be, for example, an insulating (non-conductive) resin or other organic materials. For example, the coating layer 160 may include, but is not limited to, polyethylene, polypropylene, polyvinyl butyral, polycarbonate, acrylonitrile butadiene styrene, polystyrene sulfonic acid, poly(3,4-ethylenedioxythiophene), ceramic, or combinations thereof. In some embodiments, the coating layer 160 may also include, but is not limited to, any of the following polymers: polyacrylic resins (such as polymethacrylate, polyacrylate, and polyacrylonitrile); polyvinyl alcohol; polyesters (such as polyethylene terephthalate, polyethylene naphthalate, and polycarbonate); polymers with high aromaticity (such as phenolic resin or cresol-formaldehyde, polyvinyl toluene, polyvinylxylene, polysulfone, polysulfide, polystyrene, polyimide, polyamide, polyamideimide, polyetherimide, polyphenylene sulfide, and poly(phenylene oxide)); polyurethane; epoxy resin; polyolefins (such as polypropylene, polymethylpentene, and cycloolef in); polysiloxane and other silicon-containing polymers (such as polysilsesquioxane and polysilane); synthetic rubbers (such as ethylene-propylene-diene monomer, ethylene-propylene rubber, and styrene-butadiene rubber); fluoropolymers (such as polyvinylidene fluoride, polytetrafluoroethylene, and polyhexafluoropropylene); cellulose; polyvinyl chloride; polyvinyl acetate; polynorbornene; and copolymers of fluoro-olefins and hydrocarbon olefins.

As mentioned above, since the coating layer 160 is made of a resin or organic material with good hydrophilicity and extends to the peripheral region PR, at least one side surface 101 of the peripheral region PR of the touch module 100 is a water vapor intrusion surface. In detail, the water vapor intrusion surface of the touch module 100 shown in FIG. 1 is a sidewall 161c of the topmost coating layer 160c. In other embodiments, when the topmost coating layer 160c does not extend to the inner surface 171 of the light shielding layer 170 along the sidewall of each layer, the water vapor intrusion surfaces may be sidewalls of the top coating layer 160c, the metal trace 180, and the bottom coating layer 160a.

In some embodiments, the water vapor barrier layer 140 transversely extends on the topmost coating layer 160c and covers the entire topmost coating layer 160c. In addition, the water vapor barrier layer 140 further extends to the inner surface 171 of the light shielding layer 170 along the sidewall 161c of the topmost coating layer 160c to cover the sidewall 161c of the topmost coating layer 160c, thereby preventing water vapor in the environment from intruding from the water vapor intrusion surface and attacking an electrode (e.g., the second transparent conductive layer 130). Therefore, the aggregation or even the precipitation of metal nanowires in the second transparent conductive layer 130 can be avoided, and a short circuit of the metal trace 180 can be prevented, thereby improving the electrical sensitivity of the second transparent conductive layer 130. In some embodiments, the water vapor barrier layer 140 may, for example, be conformally formed on a surface and the sidewall 161c of the topmost coating layer 160c. In some embodiments, the water vapor barrier layer 140 may include an inorganic material, such as, a silicon nitrogen compound (SiNₓ), a silicon oxygen compound, or combinations thereof. For example, the silicon nitrogen compound may be silicon nitride (Si₃N₄), and the silicon oxygen compound may be silicon dioxide (SiO₂). In other embodiments, the water vapor barrier layer 140 may be an inorganic material such as MgO—Al₂O₃—SiO₂, Al₂O₃—SiO₂, mullite, MgO—Al₂O₃—SiO₂—Li₂O, alumina, silicon carbide, carbon fiber, or combinations thereof. Compared with resin or other organic materials, the inorganic material has lower hydrophilicity, such that it can effectively prevent water vapor in the environment from intruding from the water vapor intrusion surface and attacking an electrode.

In some embodiments, a thickness H2 of the water vapor barrier layer 140 may be between 30 nm and 110 nm, in order to achieve a good water blocking effect and avoid an excessively large thickness of the entire touch module 100. In detail, when the thickness H2 of the water vapor barrier layer 140 is less than 30 nm, water vapor in the environment may not be effectively isolated; when the thickness H2 of the water vapor barrier layer 140 is greater than 110 nm, the overall touch module 100 may have an excessively large thickness, which is unfavorable for the process and seriously affects the appearance. In addition, by selection of the inorganic material of the water vapor barrier layer 140 and matching of the thickness H2 of the water vapor barrier layer 140, the water vapor barrier layer 140 can achieve a better water blocking effect. For example, when the silicon nitrogen compound is used alone as the inorganic material of the water vapor barrier layer 140, the thickness H2 of the water vapor barrier layer 140 may be set to about 30 nm. As another example, when the silicon nitrogen compound and the silicon oxygen compound are simultaneously used as the inorganic materials of the water vapor barrier layer 140, the thickness H2 of the water vapor barrier layer 140 may be set between 40 nm and 110 nm, wherein the silicon nitrogen compound and the silicon oxygen compound can be stacked, and the thickness of the silicon nitrogen compound layer may be between 10 nm and 30 nm, while the thickness of the silicon oxygen compound layer may be between 30 nm and 80 nm.

In some embodiments, the touch module 100 may further include an optically clear adhesive (OCA) layer 190 disposed between the display panel 150 and the water vapor barrier layer 140. The optically clear adhesive layer can attach the display panel 150 to the water vapor barrier layer 140, such that the display panel 150 and the substrate 110 can jointly sandwich various functional layers (such as the first transparent conductive layer 120, the second transparent conductive layer 130, the water vapor barrier layer 140, the coating layer 160, the light shielding layer 170, the metal trace 180, and the optically clear adhesive layer 190) in the touch module 100 therebetween. In some embodiments, the optically clear adhesive layer 190 may include an insulating material such as rubber, acrylic, or polyester.

In some embodiments, the optically clear adhesive layer 190 may extend to the peripheral region PR and form at least one water vapor intrusion surface in the peripheral region PR. In some embodiments, the optically clear adhesive layer 190 may have a thickness H3 of 150 μm to 200 μm. Since the thickness H3 of the optically clear adhesive layer 190 can impact the passage of the water vapor in the environment through the optically clear adhesive layer 190, the thickness H3 of the optically clear adhesive layer 190 is set to 150 μm to 200 μm, such that the passage and time required for the water vapor in the environment through the optically clear adhesive layer 190 can be extended, in order to effectively slow down the intrusion of water vapor in the environment and its attack on an electrode. This reduces the possibility of electromigration of metal nanowires and avoids an excessively large thickness of the entire touch module 100. In detail, when the thickness H3 of the optically clear adhesive layer 190 is less than 150 μm, the time for water vapor in the environment to pass through the optically clear adhesive layer 190 may be excessively short, such that the water vapor in the environment can easily intrude and attack an electrode; when the thickness H3 of the optically clear adhesive layer 190 is greater than 150 μm, the thickness of the entire touch module 100 may be excessively large, which is unfavorable for the manufacturing process and seriously affects the appearance.

In summary, the touch module 100 of the present disclosure can achieve a good water vapor barrier effect, in order to meet the specification requirements for improving product reliability tests. In some embodiments, the touch module 100 can pass an electrical test lasting for about 504 hours under specific test conditions (for example, a temperature of 65° C., a relative humidity of 90%, and a voltage of 11 V), which shows good reliability test results for the touch module 100 of the present disclosure.

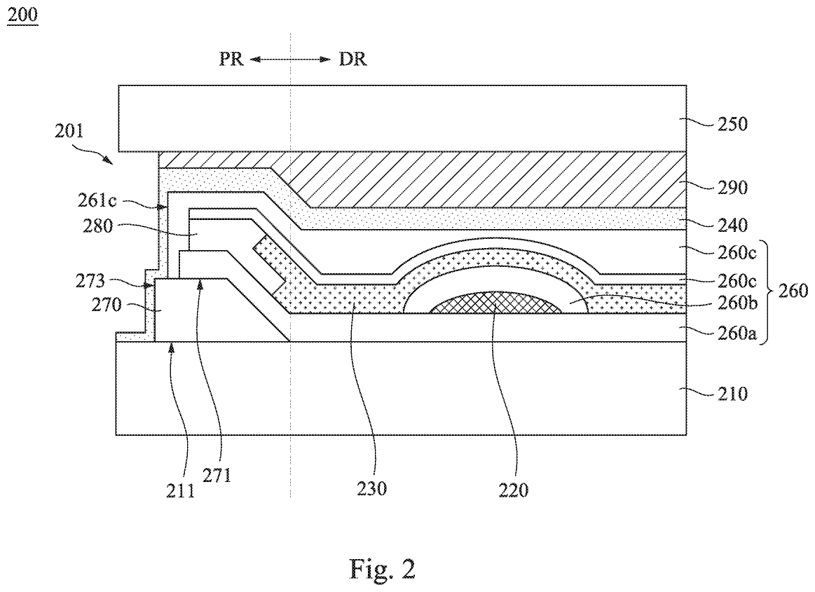

Reference is made to FIG. 2, which is a schematic side view of a touch module 200 according to some other embodiments of the present disclosure. The touch module 200 of FIG. 2 differs from the touch module 100 of FIG. 1 at least in that a water vapor barrier layer 240 of the touch module 200 further extends to an inner surface 211 of a substrate 210 along a sidewall 273 of a light shielding layer 270 and covers the sidewall 273 of the light shielding layer 270. In some embodiments, the water vapor barrier layer 240 can further transversely extend on the inner surface 211 of the substrate 210 and cover a part of the inner surface 211 of the substrate 210. In some embodiments, the water vapor barrier layer 240 may, for example, be conformally formed on a surface and a sidewall of each layer (such as a coating layer 260, the light shielding layer 270, and the substrate 210). In this way, the water vapor barrier layer 240 can more completely protect the touch module 200 from a side surface of the touch module 200, thereby better avoiding or slowing down the intrusion of water vapor in the environment and its attack on the electrode. In some embodiments, the touch module 200 can pass an electrical test lasting for about 504 hours under specific test conditions (for example, a temperature of 65° C., a relative humidity of 90%, and a voltage of 11 V), which shows good reliability test results for the touch module 200 of the present disclosure.

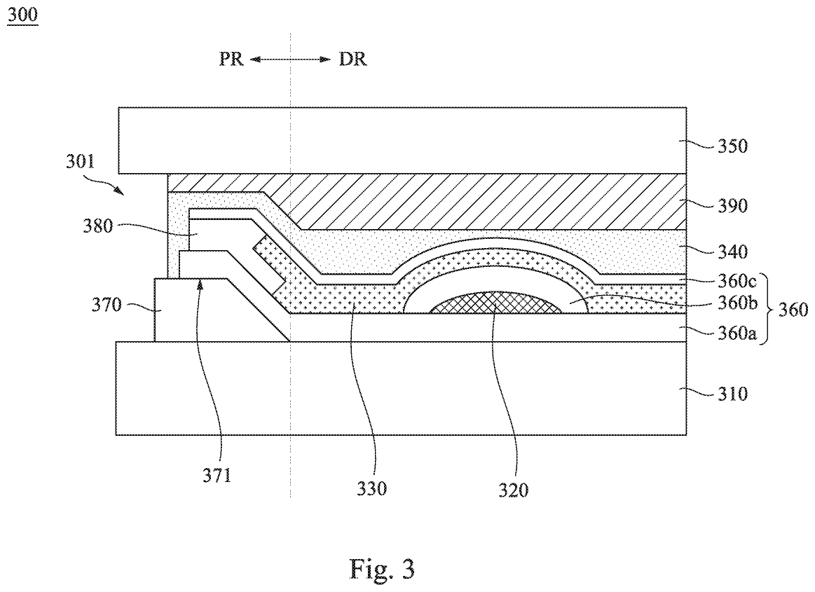

Reference is made to FIG. 3, which is a schematic side view of a touch module 300 according to some other embodiments of the present disclosure. The touch module 300 of FIG. 3 differs from the touch module 100 of FIG. 1 at least in that a water vapor barrier layer 340 in the touch module 300 replaces the topmost coating layer 160c shown in FIG. 1. In other words, the touch module 300 in FIG. 3 has only one top coating layer 360c. The top coating layer 360c is at the top of the touch module 300, and the water vapor barrier layer 340 directly covers the surface of the topmost coating layer 360c. In addition, the water vapor barrier layer 340 further extends to an inner surface 371 of a light shielding layer 370 along sidewalls of the top coating layer 360c, a metal trace 380, and a bottom coating layer 360a, and covers sidewalls of the top coating layer 360c, the metal trace 380, and the bottom coating layer 360a. In this way, the water vapor barrier layer 340 can protect the touch module 300 from a side surface of the touch module 300, thereby effectively avoiding or slowing down the intrusion of water vapor in the environment and its attack on the electrode. In addition, since the touch module 300 of FIG. 3 omits the topmost coating layer 160c compared with the touch module 100 of FIG. 1, the touch module 300 of FIG. 3 can have a reduced thickness compared with the touch module 100 of FIG. 1, in order to meet the requirement of product thinning. In some embodiments, the touch module 300 can pass an electrical test lasting for about 504 hours under specific test conditions (for example, a temperature of 65° C., a relative humidity of 90%, and a voltage of 11 V), which shows good reliability test results for the touch module 300 of the present disclosure.

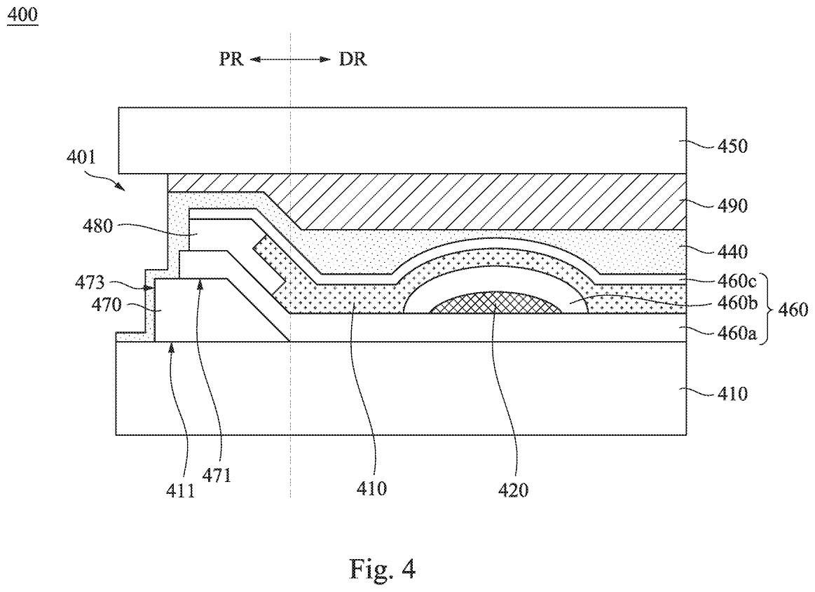

Reference is made to FIG. 4, which is a schematic side view of a touch module 400 according to some other embodiments of the present disclosure. The touch module 400 of FIG. 4 differs from the touch module 300 of FIG. 3 at least in that a water vapor barrier layer 440 of the touch module 400 further extends to an inner surface 411 of a substrate 410 along a sidewall 473 of a light shielding layer 470 and covers the sidewall 473 of the light shielding layer 470. In some embodiments, the water vapor barrier layer 440 can further transversely extend on the inner surface 411 of the substrate 410 and cover a part of the inner surface 411 of the substrate 410. In some embodiments, the water vapor barrier layer 440 may, for example, be conformally formed on a surface and a sidewall of each layer (such as a coating layer 460, a metal trace 480, the light shielding layer 470, and the substrate 410). In this way, the water vapor barrier layer 440 can more completely protect the touch module 400 from a side surface of the touch module 400, in order to better avoid or slow down the intrusion of water vapor in the environment and its attack on the electrode. In some embodiments, the touch module 400 can pass an electrical test lasting for about 504 hours under specific test conditions (for example, a temperature of 65° C., a relative humidity of 90%, and a voltage of 11 V), which shows good reliability test results for the touch module 400 of the present disclosure.

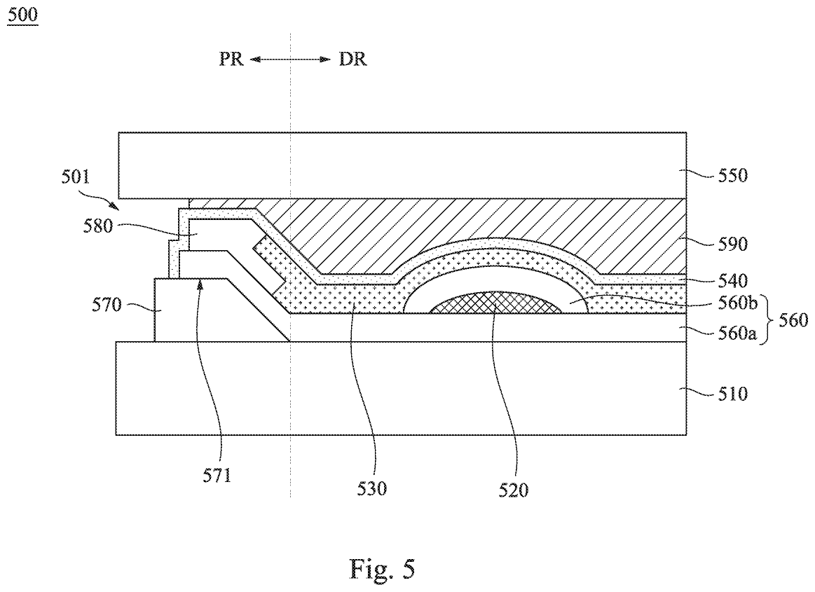

Reference is made to FIG. 5, which is a schematic side view of a touch module 500 according to some other embodiments of the present disclosure. The touch module 500 of FIG. 5 differs from the touch module 300 of FIG. 3 at least in that a water vapor barrier layer 540 in the touch module 500 replaces the topmost coating layer 360 shown in FIG. 3. In other words, the touch module 500 of FIG. 5 does not have any top coating layer, and the water vapor barrier layer 540 directly transversely extends on surfaces of a second transparent conductive layer 530 and a metal trace 580, and covers the second transparent conductive layer 530 and the metal trace 580. In addition, the water vapor barrier layer 540 further extends to an inner surface 571 of a light shielding layer 570 along sidewalls of the metal trace 580 and a bottom coating layer 560a, and covers sidewalls of the metal trace 580 and the bottom coating layer 560a. In this way, the water vapor barrier layer 540 can protect the touch module 500 from a side surface of the touch module 500, thereby effectively avoiding or slowing down the intrusion of water vapor in the environment and its attack on the electrode. In addition, since the touch module 500 of FIG. 5 does not have any top coating layer, the touch module 500 of FIG. 5 can have a less thickness compared with the touch module 300 of FIG. 3, in order to meet the requirement of product thinning. In some embodiments, the touch module 500 can pass an electrical test lasting for about 504 hours under specific test conditions (for example, a temperature of 65° C., a relative humidity of 90%, and a voltage of 11 V), which shows good reliability test results for the touch module 500 of the present disclosure.

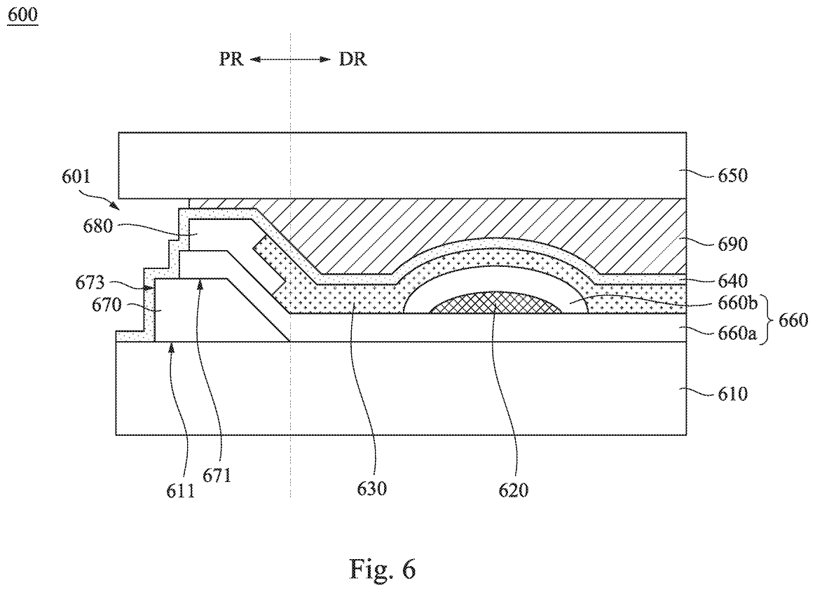

Reference is made to FIG. 6, which is a schematic side view of a touch module 600 according to some other embodiments of the present disclosure. The touch module 600 of FIG. 6 differs from the touch module 500 of FIG. 5 at least in that a water vapor barrier layer 640 of the touch module 600 further extends to an inner surface 611 of a substrate 610 along a sidewall 673 of a light shielding layer 670 and covers the sidewall 673 of the light shielding layer 670. In some embodiments, the water vapor barrier layer 640 can further transversely extend on the inner surface 611 of the substrate 610 and cover a part of the inner surface 611 of the substrate 610. In some embodiments, the water vapor barrier layer 640 may, for example, be conformally formed on a surface and a sidewall of each layer (such as a coating layer 660, a metal trace 680, the light shielding layer 670, and the substrate 610). In this way, the water vapor barrier layer 640 can more completely protect the touch module 600 from a side surface of the touch module 600, in order to better avoid or slow down the intrusion of water vapor in the environment and its attack on the electrode. In some embodiments, the touch module 600 can pass an electrical test lasting for about 504 hours under specific test conditions (for example, a temperature of 65° C., a relative humidity of 90%, and a voltage of 11 V), which shows good reliability test results for the touch module 600 of the present disclosure.

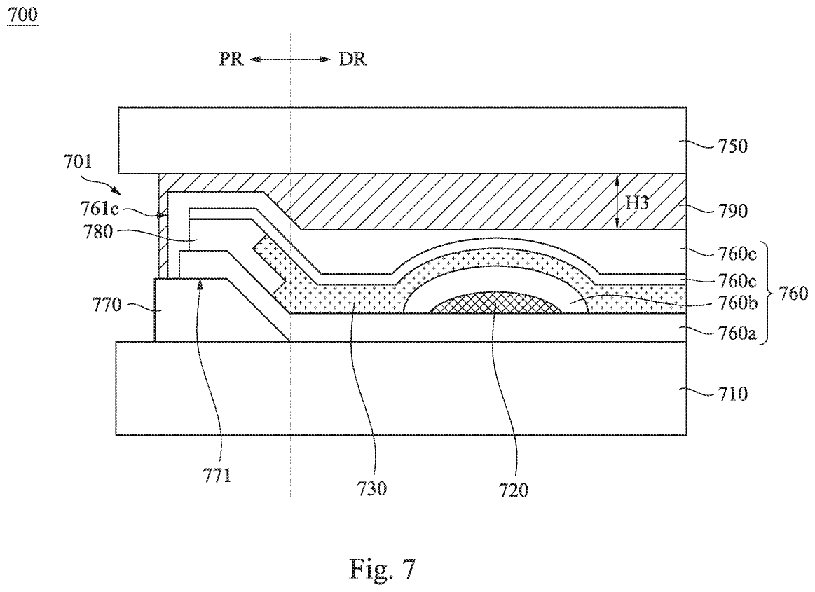

In addition to avoiding or slowing down the intrusion of water vapor in the environment and its attack on an electrode by using the water vapor barrier layer, in some embodiments, the electromigration of metal nanowires can be avoided or the time of electromigration of the metal nanowires can be slowed down by selecting material characteristics of the optically clear adhesive layer and setting its thickness H3, in order to meet the specification requirements for improving product reliability tests. In detail, reference is made to FIG. 7, which is a schematic side view of a touch module 700 according to some other embodiments of the present disclosure. The touch module 700 of FIG. 7 differs from the touch module 100 of FIG. 1 at least in that the touch module 700 of FIG. 7 does not have the water vapor barrier layer 140, and an optically clear adhesive layer 790 of the touch module 700 directly transversely extends on a topmost coating layer 760c and covers the topmost coating layer 760c. In addition, the optically clear adhesive layer 790 can further extend to an inner surface 771 of a light shielding layer 770 along a sidewall 761c of the topmost coating layer 760c to cover the sidewall 761c of the topmost coating layer 760c. Specifically, the above effects can be achieved by adjusting a dielectric constant, a water absorption at saturation, a water vapor permeability, other characteristics of the optically clear adhesive layer 790, and the thickness H3 of the optically clear adhesive layer 790, which will be explained in more detail in the following descriptions.

In some embodiments, the optically clear adhesive layer 790 may include an insulating material such as rubber, acrylic, or polyester. In some embodiments, the optically clear adhesive layer 790 may have a dielectric constant of 2.24 to 4.30. When metal ions (such as silver ions) generated by metal nanowires in a second transparent conductive layer 730 migrate into the optically clear adhesive layer 790, the dielectric constant of the optically clear adhesive layer 790 can affect a migration rate of the metal ions. Therefore, the optically clear adhesive layer 790 is made of a material having a dielectric constant of 2.24 to 4.30, such that the migration rate of the metal ions in the optically clear adhesive layer 790 can be reduced, thus reducing the electromigration possibility of the metal nanowires. In detail, when the dielectric constant of the optically clear adhesive layer 790 is less than 2.24, it may cause the metal nanowires to have a greater tendency of migrating into the optically clear adhesive layer 790, thus greatly increasing the possibility of electromigration of the metal nanowires.

In some embodiments, the optically clear adhesive layer 790 may have a water absorption at saturation of 0.08% to 0.40%. Since the water absorption at saturation of the optically clear adhesive layer 790 can affect the rate at which the optically clear adhesive layer 790 absorbs water vapor in the environment, the optically clear adhesive layer 790 is made of a material with a water absorption at saturation of 0.08% to 0.40%, such that the rate at which water vapor in the environment enters the optically clear adhesive layer 790 can be effectively reduced, in order to avoid or slow down the intrusion of water vapor in the environment and its attack on an electrode. This reduces the possibility of electromigration of metal nanowires. In detail, when the water absorption at saturation of the optically clear adhesive layer 790 is greater than 0.40%, it may cause the water vapor in the environment to enter the optically clear adhesive layer 790 at an excessively large rate, thus greatly increasing the possibility of electromigration of the metal nanowires. In some embodiments, the water absorption at saturation of the optically clear adhesive layer 790 can be measured by, for example, weighing the dried optically clear adhesive layer 790 and then soaking the dried optically clear adhesive layer 790 in water, taking out the optically clear adhesive layer 790 every 24 hours for weighing, and repeating the foregoing steps until the weight of the optically clear adhesive layer 790 does not change any more. When the weight of the optically clear adhesive layer 790 does not change any more, the water absorption of the optically clear adhesive layer 790 is the water absorption at saturation.

In some embodiments, the optically clear adhesive layer 790 may have a water vapor permeability of 37 g/(m²*day) to 1650 g/(m²*day). Since the water vapor permeability of the optically clear adhesive layer 790 can affect the rate at which water vapor in the environment passes through the optically clear adhesive layer 790, the optically clear adhesive layer 790 is made of a material with a water vapor permeability of 37 g/(m²*day) to 1650 g/(m²*day), such that the rate at which the water vapor in the environment passes through the optically clear adhesive layer 790 can be reduced, in order to effectively avoid or slow down the intrusion of water vapor in the environment and its attack on an electrode, thus reducing the possibility of electromigration of metal nanowires. In detail, when the water vapor permeability of the optically clear adhesive layer 790 is greater than 1650 g/(m²*day), it may cause the water vapor in the environment to pass through the optically clear adhesive layer 790 at an excessively large rate, such that the water vapor in the environment intrudes and attacks an electrode. This greatly increases the possibility of electromigration of the metal nanowires. It should be understood that the water vapor permeability is defined as the weight of water vapor that can pass through the optically clear adhesive layer 790 every 24 hours per unit area.

In some embodiments, the optically clear adhesive layer 790 may have a thickness H3 of 150 μm to 200 μm. Since the water vapor in the environment must pass through the optically clear adhesive layer 790, the thickness H3 of the optically clear adhesive layer 790 is set to 150 μm to 200 μm, such that the time required for the water vapor in the environment to pass through the optically clear adhesive layer 790 can be increased, in order to effectively slow down the intrusion of water vapor in the environment and its attack on an electrode. This reduces the possibility of electromigration of metal nanowires and can avoid an excessively large thickness of the entire touch module 700. In more detail, when the thickness H3 of the optically clear adhesive layer 790 is less than 150 μm, the time for water vapor in the environment to pass through the optically clear adhesive layer 790 may be excessively short, such that the water vapor in the environment can easily intrude and attack an electrode; when the thickness H3 of the optically clear adhesive layer 790 is greater than 150 μm, the thickness of the entire touch module 700 may be excessively large, which is unfavorable for the manufacturing process and seriously affects the appearance.

In detail, for the selection of the material characteristics and the setting of the thickness H3 of the optically clear adhesive layer 790, reference is made to Table 1, which specifically lists reliability test results of various embodiments of the optically clear adhesive layer 790 of the present disclosure and products (such as the touch module 700) made of the optically clear adhesive layer 790.

TABLE 1

| | Embodiment | Embodiment | Embodiment | Embodiment | Embodiment | Embodiment |
|---|---|---|---|---|---|---|
| | 1 | 2 | 3 | 4 | 5 | 6 |
| Material | Rubber | Rubber | Rubber | Acrylic | Acrylic | Acrylic |
| Dielectric | 2.56 | 2.24 | 2.30 | 2.85 | 4.30 | 2.90 |
| constant | | | | | | |
| Water | 0.10 | 0.11 | 0.08 | 0.20 | 1.10 | 0.40 |
| absorption at | | | | | | |
| saturation | | | | | | |
| (%) | | | | | | |
| Water vapor | 42 | 84 | 37 | 1350 | 1650 | 482 |
| permeability | | | | | | |
| g/(m²*day) | | | | | | |
| Thickness | 150 | 200 | 200 | 200 | 150 | 200 |
| (μm) | | | | | | |
| Reliability | 504 | 300 | 504 | 300 | 168 | 216 |
| test result | | | | | | |
| (hr) | | | | | | |

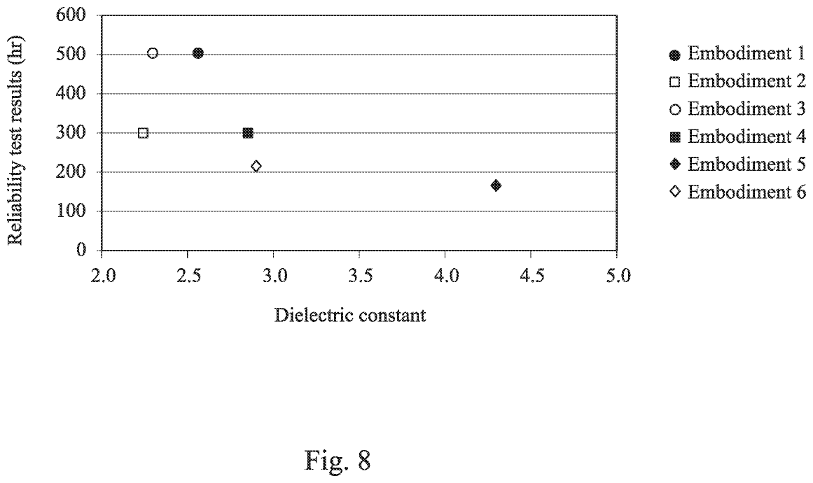

First, reference is made to Table 1 and FIG. 8, FIG. 8 is a graph of the dielectric constant vs. reliability test results drawn according to each embodiment in Table 1. It can be seen from FIG. 8 that when the dielectric constant of the optically clear adhesive layer 790 is large, the reliability test of the touch module 700 made of the optically clear adhesive layer 790 shows better results. Taking Embodiment 3 as an example, when the dielectric constant of the optically clear adhesive layer 790 is about 2.30, the touch module 700 made of the optically clear adhesive layer 790 can pass an electrical test lasting for about 504 hours under specific test conditions (for example, a temperature of 65° C., a relative humidity of 90%, and a voltage of 11 V), which shows good reliability test results for the touch module 700.

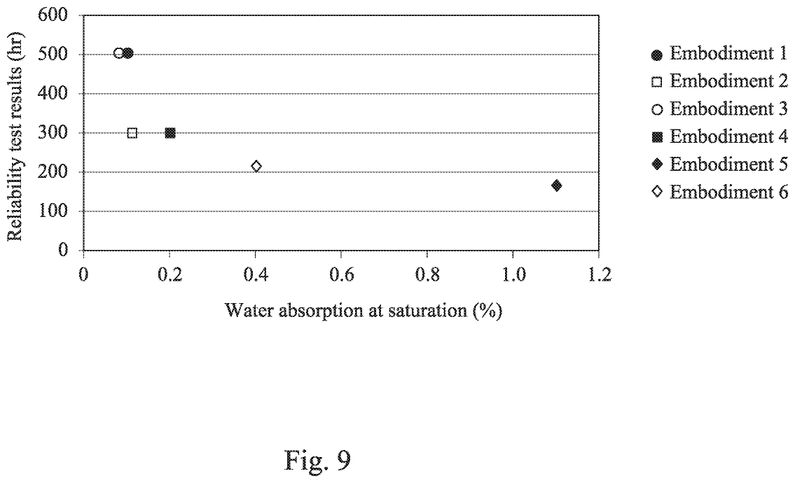

Next, reference is made to Table 1 and FIG. 9, FIG. 9 is a graph of the water absorption at saturation vs. reliability test results drawn according to each embodiment in Table 1. It can be seen from FIG. 9 that when the water absorption at saturation of the optically clear adhesive layer 790 is less, the reliability test of the touch module 700 made of the optically clear adhesive layer 790 shows better results. Taking Embodiment 3 as an example, when the water absorption at saturation of the optically clear adhesive layer 790 is about 0.08%, the touch module 700 made of the optically clear adhesive layer 790 can pass an electrical test lasting for about 504 hours under specific test conditions (for example, a temperature of 65° C., a relative humidity of 90%, and a voltage of 11 V), which shows good reliability test results for the touch module 700.

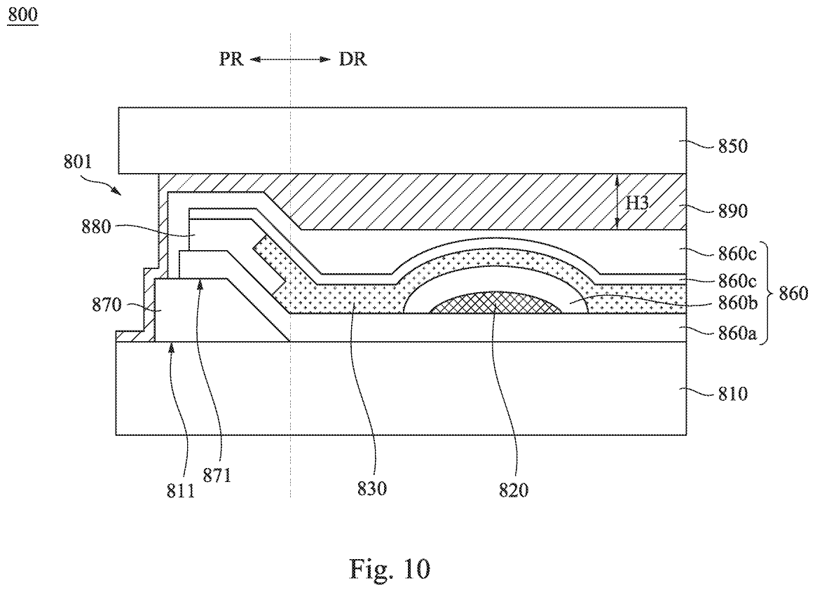

Reference is made to FIG. 10, which is a schematic side view of a touch module 800 according to some other embodiments of the present disclosure. The touch module 800 of FIG. 10 differs from the touch module 700 of FIG. 7 at least in that an optically clear adhesive layer 890 of the touch module 800 in FIG. 10 further extends to an inner surface 811 of a substrate 810 along a sidewall of a light shielding layer 870 and covers the sidewall of the light shielding layer 870. In some embodiments, the optically clear adhesive layer 890 can further transversely extend on the inner surface 811 of the substrate 810 and cover a part of the inner surface 811 of the substrate 810. In some embodiments, the optically clear adhesive layer 890 may be conformally formed on a surface and a sidewall of each layer (such as a coating layer 860 and the light shielding layer 870). In this way, the optically clear adhesive layer 890 can more completely protect the touch module 800 from a side surface of the touch module 800, thereby better avoiding or slowing down the intrusion of water vapor in the environment and its attack on the electrode. In some embodiments, the touch module 800 can pass an electrical test lasting for about 504 hours under specific test conditions (for example, a temperature of 65° C., a relative humidity of 90%, and a voltage of 11 V), which shows good reliability test results for the touch module 800 of the present disclosure.

It should be understood that the touch modules 100 to 600 shown in FIGS. 1 to 6 can also use the optically clear adhesive layers 790 to 890 shown in FIG. 7 or 10, such that the touch modules 100 to 600 shown in FIGS. 1 to 6 can be protected by optically clear adhesive layers with specific material characteristics in addition to the protection by the water vapor barrier layers 140 to 640, thus achieving better water blocking effects.

On the other hand, the touch module of the present disclosure may be, for example, a touch module that has the improved flexibility and can reduce cracks during bending. That is, the substrate and the optically clear adhesive layer applied to the touch module of the present disclosure can have a certain degree of flexibility. The flexibility of the substrate can be achieved by adjusting a tensile modulus of the substrate, and the flexibility of the optically clear adhesive layer can be achieved by adjusting a storage modulus of the optically clear adhesive layer. In the following description, the touch module 100 shown in FIG. 1 will be taken as an example for more detailed explanation.

In some embodiments, the tensile modulus of the substrate 110 may be between 2000 MPa and 7500 MPa, and the improved flexibility may be further obtained when the substrate 110 is used together with the optically clear adhesive layer 190. In detail, when the tensile modulus is less than 2000 MPa, the touch module 100 may fail to recover after bending. When the tensile modulus is greater than 7500 MPa, the optically clear adhesive layer 190 may not sufficiently reduce the excessive strength borne by the touch module 100, resulting in cracks in the touch module 100 after bending. In some embodiments, the tensile modulus of the substrate 110 can be adjusted by controlling the resin type, thickness, curing degree, and molecular weight of the substrate 110.

The substrate 110 may include, for example, a material having a tensile modulus in the foregoing range. For example, the substrate may include polyester films such as polyethylene terephthalate, polyethylene glycol isophthalate, and polybutylene terephthalate; cellulose membranes such as diacetyl cellulose and triacetyl cellulose; polycarbonate membranes; acrylic films such as polymethyl methacrylate and poly (ethyl methacrylate); styrene films such as polystyrene and acrylonitrile-styrene copolymer; polyolefin films such as polyethylene, polypropylene, cycloolefin copolymer, cycloolefin, polynorbornene, and ethylene-propylene copolymer; polyvinyl chloride membranes; polyamide membranes such as nylon and aromatic polyamide; imide membranes; sulfone membranes; polyether ketone membranes; allyl compound membranes; polyphenylene sulfide membranes; vinyl alcohol membranes; vinylidene chloride membranes; polyvinyl butyral membranes; polyformaldehyde membranes; carbamate membranes; silicon films; and epoxy films. In addition, the thickness of the substrate 110 can be appropriately adjusted within the foregoing range of the tensile modulus. For example, the substrate 110 may have a thickness of 10 μm to about 200 μm.

In some embodiments, the storage modulus of the optically clear adhesive layer 190 at a temperature of about 25° C. is less than 100 kPa, and when the optically clear adhesive layer 190 is used together with the substrate 110 having the foregoing tensile modulus range, the stress during bending can be reduced to reduce cracks. In some embodiments, the storage modulus of the optically clear adhesive layer 190 at a temperature of about 25° C. may be between 10 kPa and 100 kPa. In addition, since the touch module 100 can be used in various environments, its flexibility in lower temperature environments also needs to be improved. In some embodiments, the storage modulus of the optically clear adhesive layer 190 at a temperature of about −20° C. may be less than or equal to 3 times its storage modulus at a temperature of about 25° C., such that the optically clear adhesive layer 190 may also have improved flexibility at low temperatures. In some embodiments, the optically clear adhesive layer 190 may be, for example, a (meth) acrylic transparent adhesive layer, an ethylene/vinyl acetate copolymer transparent adhesive layer, a silicon transparent adhesive layer (such as a copolymer of silicon resin and silicone resin), a polyurethane transparent adhesive layer, a natural rubber transparent adhesive layer, or a styrene-isoprene-styrene block copolymer transparent adhesive layer. In some embodiments, the storage modulus of the optically clear adhesive layer 190 at temperatures of about 25° C. and about −20° C. can be within the foregoing range by increasing the proportion of monomers with a low glass transition temperature (for example, below −40° C.) among all monomers in the material of the optically clear adhesive layer 190, or by increasing the proportion of resins with low functionality (for example, below 3) among all resins.

It is noted that the connection relationships, the materials, and the advantages of the elements described above will not be repeated. In the following description, the touch module 100 shown in FIG. 1 will be taken as an example to further describe a method for manufacturing the touch module 100.

First, a substrate 110 having a predefined display region DR and peripheral region PR is provided, and a light shielding layer 170 is formed in the peripheral region PR of the substrate 110 to shield a peripheral wire (such as a metal trace 180) formed subsequently. Then, a bottom coating layer 160a is formed on the substrate 110 and further extends to an inner surface 171 of the light shielding layer 170 to cover a part of the light shielding layer 170. In some embodiments, the bottom coating layer 160a can be configured to adjust surface characteristics of the substrate 110, in order to facilitate a subsequent coating process of a metal nanowire layer (such as a second transparent conductive layer 130), and to help improve the adhesion between the metal nanowire layer and the substrate 110. Next, a transparent conductive material (such as indium tin oxide, indium zinc oxide, cadmium tin oxide, or aluminum-doped zinc oxide) is formed on the bottom coating layer 160a, in order to obtain, after patterning, a first transparent conductive layer 120 located in the display region DR and used as a conductive electrode. Then, an intermediate coating layer 160b is formed to cover the first transparent conductive layer 120, such that the first transparent conductive layer 120 can be insulated from a second transparent conductive layer 130 formed subsequently.

Next, the metal material is formed on the bottom coating layer 160a, and a metal trace 180 located in the peripheral region PR is obtained after patterning. In some embodiments, the metal material can be directly and selectively formed in the peripheral region PR rather than in the display region DR. In other embodiments, the metal material can be integrally formed in the peripheral region PR and the display region DR, and then the metal material located in the display region DR can be removed by lithography and etching and other steps. In some embodiments, the metal material can be deposited in the peripheral region PR of the substrate 110 by chemical plating. The chemical plating is to reduce metal ions in a plating solution to metal, by means of a suitable reducing agent, under the catalysis of a metal catalyst without an impressed current, and coat the metal onto the surface to be chemically plated. This process can also be referred to as electroless plating or autocatalytic plating. In some embodiments, the catalytic material can be first formed in the peripheral region PR of the substrate 110 rather than in the display region DR of the substrate 110. Since no catalytic material is in the display region DR, the metal material is only deposited in the peripheral region PR rather than in the display region DR. During the electroless plating reaction, the metal material can nucleate on the catalytic material capable of catalytic/activation, and then continue to grow into a metal film by self-catalysis of the metal material. The metal trace 180 of the present disclosure can be made of a metal material with a better conductivity, preferably a single-layer metal structure, such as a silver layer or a copper layer; or can be a multi-layer metal structure, such as a molybdenum/aluminum/molybdenum layer, a titanium/aluminum/titanium layer, a copper/nickel layer, or a molybdenum/chromium layer, but it is not limited thereto. The metal structure is preferably opaque. For example, the light transmittance of the metal structure for visible light (such as with a wavelength between 400 nm and 700 nm) is less than about 90%.

Then, the second transparent conductive layer 130 serving as a conductive electrode is formed on the bottom coating layer 160a, the intermediate coating layer 160b, and the metal trace 180. In detail, a first portion of the second transparent conductive layer 130 is located in a display region DR and attached to surfaces of the bottom coating layer 160a and the intermediate coating layer 160b, while a second portion of the second transparent conductive layer 130 is located in the peripheral region PR and attached to the surfaces of the bottom coating layer 160a and the metal trace 180. In some embodiments, the second transparent conductive layer 130 can be formed by coating, curing, drying forming, lithography, etching, and other steps using a dispersion or slurry including metal nanowires. In some embodiments, the dispersion may include a solvent, such that the metal nanowires are uniformly dispersed therein. Specifically, the solvent may be, for example, water, alcohols, ketones, ethers, hydrocarbons, aromatic solvents (benzene, toluene, or xylene), or combinations thereof. In some embodiments, the dispersion may further include additives, surfactants, and/or adhesives, in order to improve the compatibility between metal nanowires and the solvent and the stability of the metal nanowires in the solvent. Specifically, the additives, the surfactants, and/or the adhesives may be, for example, sulfonate, sulfate, phosphate, disulfonate, carboxymethyl cellulose, hydroxyethyl cellulose, hydroxypropyl methylcellulose, sulfosuccinate, fluorine-containing surfactants, or combinations thereof.

In some embodiments, the coating step may include, but is not limited to, processes such as screen printing, nozzle coating, or roller coating. In some embodiments, a roll-to-roll process may be adopted to uniformly coat the dispersion including metal nanowires onto surfaces of the continuously supplied bottom coating layer 160a, the intermediate coating layer 160b, and the metal trace 180. In some embodiments, the curing and drying forming steps can volatilize the solvent and make the metal nanowires randomly distributed on the surfaces of the bottom coating layer 160a, the intermediate coating layer 160b, and the metal trace 180. In some embodiments, the metal nanowires can be fixed on the surfaces of the bottom coating layer 160a, the intermediate coating layer 160b, and the metal trace 180 without falling off, and the metal nanowires can be in contact with one another to provide a continuous current path, thereby forming a conductive network.

In some embodiments, the metal nanowires can be further post-treated to improve their conductivity, and the post-treatment includes, for example, but is not limited to, heating, plasma, corona discharge, ultraviolet rays, ozone, pressurizing, and other steps. In some embodiments, one or more rollers may be used to apply a pressure to the metal nanowires. In some embodiments, the applied pressure may be between 50 psi and 3400 psi. In some embodiments, the metal nanowires are subjected to post-treatment by heating and pressing at the same time. In some embodiments, the roller can be heated from 70° C. to 200° C. In some embodiments, the metal nanowires can be exposed to a reducing agent for post-treatment. For example, when the metal nanowires are silver nanowires, they can be exposed to a silver reducing agent for post-treatment. In some embodiments, the silver reducing agent may include a borohydride such as sodium borohydride, a boron nitrogen compound such as dimethylamine borane, or a gaseous reducing agent such as hydrogen. In some embodiments, the exposure may be performed for 10 seconds to 30 minutes.

Next, at least one top coating layer 160c is formed to cover the second transparent conductive layer 130. In some embodiments, the material of the top coating layer 160c can be formed on the surface of the second transparent conductive layer 130 by coating. In some embodiments, the material of the top coating layer 160c may further penetrate between the metal nanowires of the second transparent conductive layer 130 to form a filler that is then cured to form a composite structure layer with the metal nanowires. In some embodiments, the material of the top coating layer 160c can be dried and cured by heating and baking. In some embodiments, the heating and baking may be performed at a temperature of 60° C. to 150° C. It should be understood that the physical structure between the top coating layer 160c and the second transparent conductive layer 130 is not intended to limit the present disclosure. In detail, the top coating layer 160c and the second transparent conductive layer 130 may be, for example, a stack of two layers, or may be mixed with one another to form a composite structure layer. In some embodiments, the metal nanowires in the second transparent conductive layer 130 are embedded in the top coating layer 160c to form a composite structure layer.

Then, a structure (semi-product) including at least the substrate 110, the first transparent conductive layer 120, the second transparent conductive layer 130, and the coating layer 160 is placed in a vacuum coating device for vacuum coating, such that the water vapor barrier layer 140 is formed on the surface and the sidewall 161c of the top coating layer 160c. Since the water vapor barrier layer 140 is plated on the surface and the sidewall 161c of the top coating layer 160c in a vacuum environment, the water vapor barrier layer 140 can be in tighter lap joint with the surface and the sidewall 161c of the top coating layer 160c. This ensures that no gap exists between the water vapor barrier layer 140 and the top coating layer 160c and improves the yield of products. In addition, the water vapor barrier layer 140 formed in the vacuum environment can have a more compact structure, thereby better preventing water vapor in the environment from intruding into and attacking an electrode. On the other hand, a structure including the substrate 110, the first transparent conductive layer 120, the second transparent conductive layer 130, and the coating layer 160 is placed in the vacuum coating device such that the layers can be stacked more tightly, thereby reducing the impedance between the layers. More specifically, reference is made to Table 2, which specifically lists the impedance values measured before and after vacuum coating of the touch module 100 in each embodiment of the present disclosure.

TABLE 2

| | Embodiment | Embodiment | Embodiment | Embodiment | Embodiment | Embodiment | Embodiment |
|---|---|---|---|---|---|---|---|
| | 1 | 2 | 3 | 4 | 5 | 6 | 7 |
| Impedance | 28.32 | 28.31 | 35.11 | 36.96 | 25.68 | 31.06 | 26.31 |
| values before | | | | | | | |
| vacuum coating | | | | | | | |
| (Ω) | | | | | | | |
| Impedance | 22.83 | 27.03 | 31.01 | 22.09 | 21.26 | 28.07 | 25.05 |
| values after | | | | | | | |
| vacuum coating | | | | | | | |
| (Ω) | | | | | | | |
| Impedance | 19.39 | 4.52 | 11.68 | 18.06 | 17.21 | 9.63 | 4.79 |
| change rate (%) | | | | | | | |

It can be seen from Table 2 that the impedance value measured by the touch module 100 of each embodiment of the present disclosure after vacuum coating is obviously less than that measured before vacuum coating. Take Embodiment 1 as an example. The maximum change rate of impedance values before and after vacuum coating can be about 19.39%, which shows that the foregoing vacuum coating method can effectively reduce the impedance values of the touch module 100.

Next, the optically clear adhesive layer 190 is formed on the water vapor barrier layer 140, in order to fix the display panel 150 by the optically clear adhesive layer 190. In some embodiments, the material of the optically clear adhesive layer 190 can be formed on the surface of the water vapor barrier layer 140 by coating. In other embodiments, the material of the optically clear adhesive layer 190 can also be formed on the surface of the water vapor barrier layer 140 by using the foregoing vacuum coating method, such that the lap joint between the optically clear adhesive layer 190 and the water vapor barrier layer 140 becomes tighter, in order to improve the yield of products.

In summary, the present disclosure provides a touch module with a water vapor barrier layer and/or an optically clear adhesive layer made of a suitable material. The water vapor barrier layer and/or the optically clear adhesive layer made of a suitable material can reduce intrusion of water vapor in the environment. The optically clear adhesive layer made of a suitable material can also slow down the water vapor transmission and the migration rate of metal ions generated by metal nanowires, in order to avoid electromigration of the metal nanowires or slow down the electromigration time of the metal nanowires, thereby meeting the specification requirements of improving product reliability tests.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A touch module, comprising:
a substrate;
a transparent conductive layer disposed on the substrate; and
a water vapor barrier layer transversely extending on the transparent conductive layer, covering the transparent conductive layer, and comprising an inorganic material.

2. The touch module of claim 1, wherein the inorganic material comprises a silicon nitrogen compound (SiNₓ), a silicon oxygen compound, or combinations thereof.

3. The touch module of claim 1, wherein the water vapor barrier layer has a thickness of 30 nm to 110 nm.

4. The touch module of claim 1, wherein the water vapor barrier layer extends to an inner surface of the substrate along a sidewall of the transparent conductive layer.

5. The touch module of claim 1, wherein the transparent conductive layer comprises a matrix and a plurality of metal nanostructures distributed in the matrix.

6. The touch module of claim 1, further comprising at least one coating layer disposed between the water vapor barrier layer and the transparent conductive layer.

7. The touch module of claim 6, wherein the water vapor barrier layer extends along a sidewall of the coating layer to cover the coating layer.

8. The touch module of claim 1, further comprising a light shielding layer disposed between the transparent conductive layer and the substrate.

9. The touch module of claim 8, wherein the water vapor barrier layer extends along a sidewall of the light shielding layer to cover the light shielding layer.

10. The touch module of claim 1, further comprising an optically clear adhesive layer disposed between the water vapor barrier layer and the transparent conductive layer, wherein the optically clear adhesive layer has a water absorption at saturation of 0.08% to 0.40%.

11. A touch module, comprising:
a substrate;
a transparent conductive layer disposed on the substrate; and
an optically clear adhesive layer transversely extending on the transparent conductive layer, wherein the optically clear adhesive layer has a water absorption at saturation of 0.08% to 0.40% and a water vapor permeability of 37 g/(m²*day) to 1650 g/(m²*day).

12. The touch module of claim 11, wherein the optically clear adhesive layer has a dielectric constant of 2.24 to 4.30.

13. The touch module of claim 11, wherein the optically clear adhesive layer has a thickness of 150 μm to 200 μm.

14. The touch module of claim 11, wherein the optically clear adhesive layer extends to an inner surface of the substrate along a sidewall of the transparent conductive layer.

15. The touch module of claim 11, further comprising at least one coating layer disposed between the optically clear adhesive layer and the transparent conductive layer.

16. The touch module of claim 15, wherein the optically clear adhesive layer extends along a sidewall of the coating layer to cover the coating layer.

17. The touch module of claim 11, further comprising a light shielding layer disposed between the transparent conductive layer and the substrate.

18. The touch module of claim 17, wherein the optically clear adhesive layer extends along a sidewall of the light shielding layer to cover the light shielding layer.

19. The touch module of claim 17, wherein the optically clear adhesive layer extends to an inner surface of the light shielding layer along a sidewall of the transparent conductive layer.

20. The touch module of claim 11, further comprising a water vapor barrier layer disposed between the optically clear adhesive layer and the transparent conductive layer, wherein the water vapor barrier layer comprises an inorganic material.

21. A touch display module, comprising:
a substrate;
a transparent conductive layer disposed on the substrate;
a water vapor barrier layer transversely extending on the transparent conductive layer, covering the transparent conductive layer, and comprising an inorganic material; and
a display panel disposed on the water vapor barrier layer.
